(19) United States
(12) Patent Application Publication
(10) Pub. No.: US 2006/0049891 A1
(43) Pub. Date: Mar. 9, 2006

(54) PHASE NOISE REDUCTION DEVICE

(75) Inventor: Denis-Gerard Crete, Paris (FR)

Correspondence Address: LOWE HAUPTMAN GILMAN & BERNER, LLP, 1700 DIAGNOSTIC ROAD, SUITE 300, ALEXANDRIA, VA, 22314, US

(73) Assignee: THALES, Neuilly Sur Seine (FR)

(21) Appl. No.: 10/534,587

(22) PCT Filed: Nov. 7, 2003
(86) PCT No.: PCT/EP03/50801

§ 371 Date: May 11, 2005

(30) Foreign Application Priority Data
Nov. 12, 2002 (FR) 02 14124

(51) Int. Cl. H01P 1/04

(52) U.S. Cl. 333/99 S

(57) ABSTRACT

A device for reducing the phase noise of a signal (Sᵢₙ), coming from a quasiperiodic source of fundamental frequency f₀, comprises a superconducting circuit with an active line for voltage pulse transmission by transferring quanta of flux φ₀. This circuit is defined so as to have a characteristic frequency f_{c} such that 0.3 f_{c}, is less than or equal to the fundamental frequency f₀ of the quasiperiodic signal (Sᵢₙ) applied as input, and delivers, as output, a voltage pulse signal of fundamental frequency f₀.

The present invention relates to a device for reducing the phase noise in a signal coming from a quasiperiodic source.

It applies more particularly to superconducting logic circuits, especially to logic circuits in RSFQ (Rapid Single Flux Quantum) technology.

In general, logic systems use at least one clock signal for the sequencing and synchronization functions. The clock signals are usually generated by oscillators. These quasiperiodic signals are not completely pure, despite the integration of resonant filters in the oscillators. If we consider the representation of the spectral density of a quasiperiodic signal generated by an oscillator, a noise floor is thus observed. This is the white noise of the spectrum, corresponding to a short-term phase noise of the quasiperiodic signal. The phase lock circuits normally used in digital systems (computers or other systems) do not allow this short-term phase noise to be reduced—their action has a long-term stabilizing effect in order to prevent frequency drifts.

In what follows, the term “phase noise” is understood to mean the noise corresponding to the noise floor or white noise of the frequency spectrum of the signal. The subject of the invention is a device for reducing this phase noise. Such a device is particularly beneficial in the field of rapid digital electronics. In particular, it makes it possible to reduce the jitter in the clock signal, this being particularly irksome in digital circuits operating at high and very high frequency.

In rapid digital electronic systems, a logic family using superconducting circuits has been developed. This is the RSFQ (Rapid Single Flux Quantum) logic family based on the use of the quantization of the magnetic flux and the transfer of single flux quanta φ₀. In this approach, the logic data processing amounts to manipulating voltage pulses resulting from the passage of the flux quanta in current loops. One of the basic elements of this logic family based on superconductors is the shunted Josephson junction, which allows a single flux quantum to be transferred or retained, the passage of a flux quantum into the junction resulting in the appearance of a voltage pulse at its terminals such that ∫Vdt=h/2e=φ₀=2.07×10⁻¹⁵ weber (h being Planck's constant). With current technologies, the voltage pulse therefore has an amplitude of the order of 2 millivolts over 1 picosecond.

Each junction is defined by a critical current I_{c} and a normal resistance Rₙ, dependent on its geometry and on the technology used. The propagation/transfer function is provided by a bias current control of the appropriate junction, which allows the current flowing through the junction to be increased or decreased, thus making it possible to retain the flux quantum in the loop or to transfer the flux quantum through the junction into the next loop.

RSFQ logic has resulted in many logic circuits such as analog/digital converters, random access memories and processors for signal processing that calculate rapid Fourier transforms, which may operate at very high frequency. The upper operating limit of RSFQ logic elements is given by their critical frequency, which depends on their geometry and on the technology employed (three-layer, planar, etc.). This characteristic frequency is given by the following equation:
f_{c}=I_{c}Rₙ/φ₀
where I_{c}, is the critical current of the junction, Rₙ is the normal resistance and φ₀ is the flux quantum, equal to 2.07×10⁻⁵ weber.

A useful review of applications in RSFQ logic will be found in the article by Konstantin K. Likharev “Progress and prospects of superconducting electronics”, Superconducting Science Technology, 3 (1990), pages 325-337.

Another active element of RSFQ logic is the Josephson transmission line. A Josephson transmission line is a line comprising parallel-shunted Josephson junctions coupled between them by superconducting inductors. Such a line allows propagation of single flux quanta, and therefore serves as a logic data transport medium. A very short voltage pulse, of the order of 2 millivolts over 1 picosecond, applied as input of such a line, propagates along this line by propagation of a flux quantum φ₀, also called a fluxon, through permanent current loops. This voltage pulse is recovered at the output. These Josephson transmission lines allow logic pulse transmission without any distortion.

If two pulses are applied in succession as input, two fluxons are generated in the line and propagate along this line. These two fluxons are separated in the line by a distance representative of the time interval separating the two pulses applied as input. However, because of a repulsive interaction between the fluxons generated, if the distance d between the two fluxons is short enough for this repulsive interaction to be of significant strength, spatial redistribution takes place in the line, which is manifested at the output by a time interval separating the two pulses that differs from that observed at the input of the line. In other words, one pulse has been accelerated and the other slowed down in the line. This effect has been clearly explained in an article entitled “Fluxon interaction in an overdamped Josephson transmission line” by V. K. Kaplunenko, Applied Physics Letters, 66 (24), Jun. 12, 1995, with a numerical illustration of this effect observed experimentally on a Josephson transmission line comprising 200 shunted Josephson junctions coupled in parallel by a superconducting inductor and having a characteristic frequency f_{c}, of 104 GHz. Two voltage pulses 9.6 ps (picoseconds) apart, corresponding to f_{c}⁻¹, are applied as input to this line. The time interval between the two fluxons propagating along the line increases. At the output, two voltage pulses 27 ps apart are obtained. Owing to the repulsion between the fluxons, one pulse has been slowed down and the other speeded up, resulting in an increase in the time interval separating the two pulses. This modification phenomenon is observed in practice only for an interfluxon distance corresponding to a time interval of less than a saturation time of the junction, evaluated to 3 f_{c}⁻¹, i.e. around 28.8 ps in the example. If the distance between the fluxons is too great, the force is not high enough. It is therefore necessary for the fluxons generated to be sufficiently close so that the force is high. In the example, if two pulses 30 picoseconds apart are injected into the line, this time interval at the output of the line is unchanged.

A sequence of bits representing logic data may thus be modified in the Josephson transmission line owing to the effect of the repulsive interaction between the fluxons, this being equivalent to a loss of logic information. In a logic system, this loss of information may have serious repercussions, namely raw information loss, desynchronization (phase comparator), etc. To avoid this interaction problem, the author of the article recommends designing the line so that the time interval between two fluxons generated in the line is not less than 3 f_{c}⁻¹, i.e. 28.8 ps (saturation value) in the example. A suitable design is obtained in particular by varying the critical current, the normal resistance and the inductances in the definition of the circuit. The interaction effects can then be reduced in operation by varying the bias current of the Josephson junctions.

In the invention, this repulsive interaction effect between the fluxons is of use for withdrawing an advantageous technical effect therefrom, in respect of the filtration of the white noise of a signal coming from a quasiperiodic source. The basic notion of the invention is to use this effect on a series of pulses from a clock signal coming from any quasiperiodic source of fundamental frequency f₀ in order to lower the white noise level of this signal relative to the level of the fundamental. This is because, if we take the case of a clock signal of the type consisting of voltage pulses, the white noise level results in a temporal dispersion of the pulses of the signal, and consequently in a dispersion of the spatial distance between the fluxons generated in the superconducting transmission line.

The interaction effect over the entire length of the line means that a redistribution of the fluxons within the confined space of the line is observed, due to the random behavior of large numbers about a smooth value, corresponding to a mean value of the interfluxon distance. This spatial redistribution of the fluxons has as direct effect the temporal redistribution of the pulses at the output.

The white noise of the quasiperiodic signal is manifested, on the signal, by a temporal dispersion of the pulses and, in the superconducting transmission line, by a dispersion of the spatial distance between two successive fluxons.

Owing to the periodic nature of the signal at the input, the fluxons are organized in the line as a periodic lattice. In the Josephson transmission line, this is a one-dimensional periodic lattice along the direction of propagation of the flux quanta. After a certain number of pulses, corresponding to a transient delay, a redistribution of this lattice takes place, with a smooth interfluxon distance around a mean value. Thus the phenomenon of interfluxon repulsion, combined with the statistics of large numbers, leads to a uniform redistribution of the fluxons within the lattice, thereby resulting, at the output of the line, in a reduction in the white noise level of the quasiperiodic signal.

In general, according to the invention, taking any physical system capable of generating particles having repulsive interactions between them for an inter-particle distance shorter than a saturation value of the system (characteristic frequency), such as electrons (quantronic circuits), flux quanta or vortices, it is possible to reduce the phase noise by reorganizing the particle lattice in the physical system.

The invention therefore relates to a device for reducing the phase noise of a signal coming from a quasiperiodic source of fundamental frequency f₀. According to the invention, this device comprises a physical system for transmitting pulses by transferring particles, said system being defined so as to have a characteristic frequency f_{c} defining an operating frequency range of the device with a low limit that is dependent on said characteristic frequency, in such a way that, for the quasiperiodic signal applied as input, said particles have a mutual repulsive interaction and said system delivering, as output, pulses at the fundamental frequency f₀.

The invention also relates to a device for reducing the phase noise of a signal coming from a quasiperiodic source of fundamental frequency f₀. According to the invention, it comprises a superconducting circuit with an active line for voltage pulse transmission by transferring quanta of flux φ₀, said circuit being defined so as to have a characteristic frequency f_{c} such that 0.3f_{c}≦f₀ where f₀ is the fundamental frequency of the quasiperiodic signal (Sᵢₙ) applied as input, and delivering, as output, a voltage pulse signal of fundamental frequency f₀.

The phase noise reduction may be improved by defining a superconducting circuit consisting of an active voltage pulse transmission line, such that the flux quanta generated in the circuit owing to the effect of applying the quasiperiodic signal are organized along a two-dimensional periodic lattice. Thus, the interactions between the flux quanta take place between closest neighbors along the two dimensions of the lattice.

The invention applies not only to the flux quanta generated in a Josephson transmission line, but more generally to any superconducting circuit based on active voltage pulse transmission line. In particular, it also applies to vortex flux transmission lines, namely transmission lines with a long Josephson junction, with Josephson vortex flux flow, with a slot or microbridge line, or with Abrikosov vortex flux flow.

The phase reduction device may furthermore be used advantageously in a frequency multiplier circuit.

Other advantages and features of the invention will become more clearly apparent on reading the following description, given by way of non-limiting indication of the invention and with reference to the appended drawings in which:

FIG. 1, already described, illustrates the spectral density A(Sᵢₙ) of a signal coming from a quasiperiodic source;

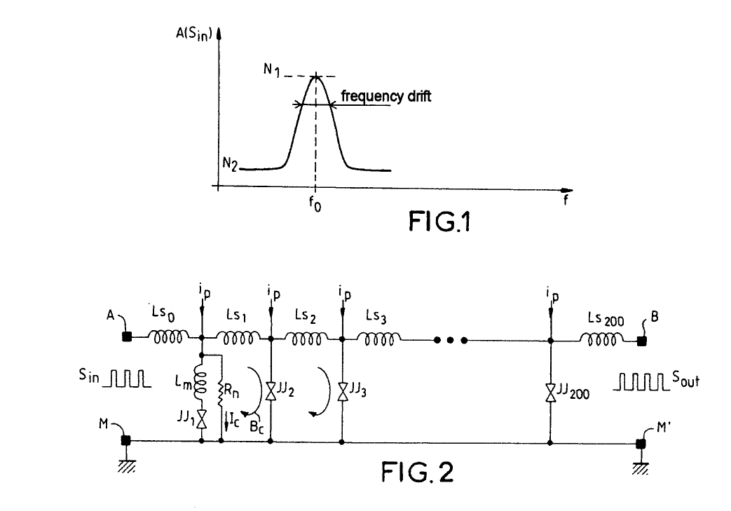

FIG. 2 shows a circuit diagram of a phase reduction device according to the invention based on a Josephson transmission line comprising a plurality of Josephson junctions;

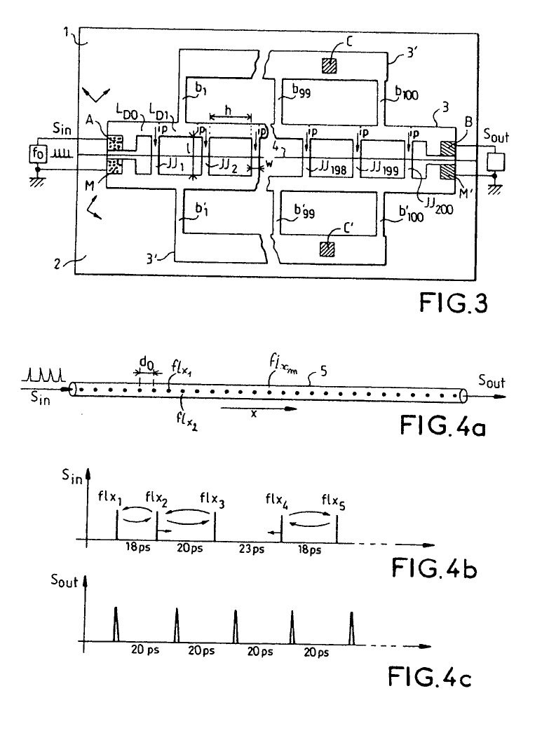

FIG. 3 shows a first example of an embodiment of such a line, in a bicrystal multijunction technology;

FIG. 4a shows schematically a periodic lattice of fluxons generated by a pulse clock signal in the Josephson transmission line;

FIGS. 4b and 4c illustrate the phenomenon of temporal redistribution of the voltage pulses in such a line;

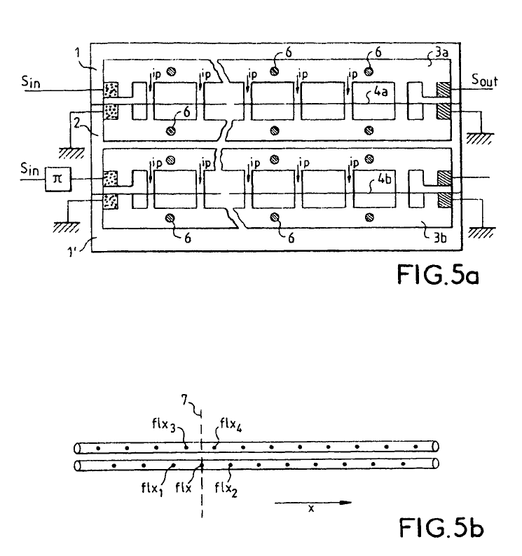

FIG. 5a shows another example of an embodiment of a phase reduction device comprising two Josephson transmission lines placed in parallel in the same surface plane;

FIG. 5b is an illustration of the periodic lattice of the corresponding fluxons;

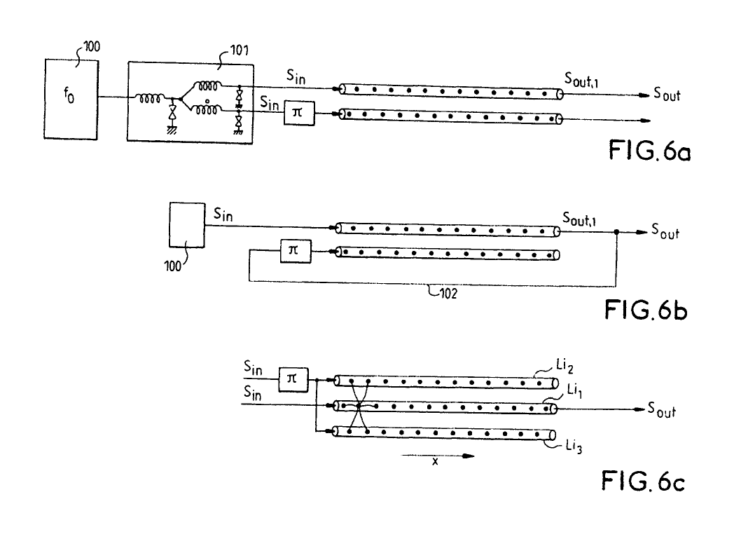

FIGS. 6a and 6b illustrate schematically two alternative ways of using two Josephson transmission lines in parallel in a phase reduction device so as to improve the effectiveness of the correction;

FIG. 6c is an alternative to the previous figures with n=3 Josephson transmission lines in parallel, with an illustration of the periodic lattice of the corresponding fluxons;

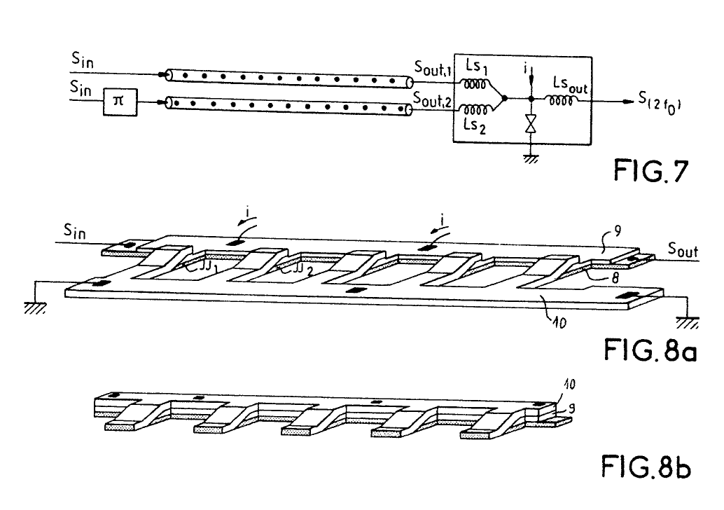

FIG. 7 shows an example of the use of a phase noise reduction device in a frequency doubling circuit;

FIGS. 8a and 8b show another example of a phase reduction device based on a Josephson transmission line produced in a ramp-edge junction technology;

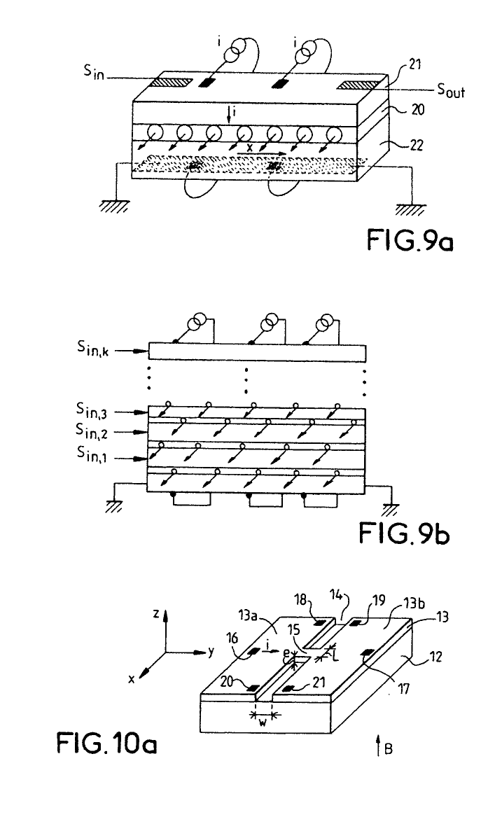

FIGS. 9a and 9b show two embodiments of a phase noise reduction device based on a long Josephson junction transmission line;

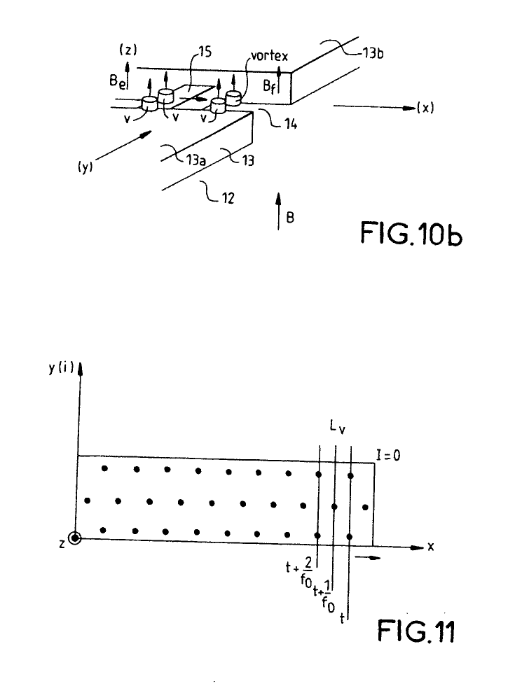

FIGS. 10a and 10b show a phase noise reduction device based on a vortex-flux, slot or microbridge line; and

FIG. 11 is an illustration of the periodic lattice of the vortices generated in such a line.

FIG. 1 shows the spectral density A(Sᵢₙ) of a signal Sᵢₙ coming from a quasiperiodic source and applied as clock signal in a logic system. In the invention, the aim is to reduce the phase noise/signal ratio N₂/N₁, which is around −115 to −120 dB_{c} for signals coming from conventional quasiperiodic sources (oscillators) by at least a factor of 10. Such a reduction is particularly advantageous in the field of electronics operating at very high frequency and in particular in systems based on high-T_{c} (high critical temperature) superconducting RSFQ logic circuits in which the thermal noise is low. The benefit of a signal whose short-term noise has been singularly reduced is then put to full use.

FIG. 2 illustrates a first embodiment of a phase noise reduction device according to the invention, comprising a superconducting circuit based on a voltage pulse transmission line, at the input of which the signal Sᵢₙ to be processed is applied, and the circuit delivers, as output, a signal Sₒᵤₜ whose phase noise has been reduced.

In this example, the transmission line is a Josephson transmission line comprising a plurality of Josephson junctions JJ₁, JJ₂, . . . JJ₂₀₀, shown as their simplified circuit diagram. The Josephson junctions are shunted, mounted in parallel, and coupled to one another via superconducting inductors Ls₁, Ls₂, Ls₃, . . . Ls₂₀₀. A superconducting inductor Ls₀ is also provided at the input, between an input signal electrode A and the first Josephson junction JJ₁.

The input signal is applied to the terminals of the line, between two input signal electrodes A and M. The output signal Sₒᵤₜ is obtained at the output of the line, between two output signal electrodes B and M′. The electrodes M and M′ are the ground electrodes of the line. The junctions are biased with current I_{b}, which is less than the critical current I_{c} of the junctions, so that a permanent current loop B_{c} is established in each cell closed off by a junction.

The application of a pulse at the input of such a line increases the current of the junction to above the critical current. The Josephson effect occurs—a flux quantum passes through the current loop and a corresponding voltage pulse appears at the terminals of the junction. The voltage pulse thus propagates along the line, without being distorted.

If a clock signal pulse train is applied, a corresponding train is recovered at the output. According to the invention, the characteristics of the line are chosen so as to obtain a given characteristic frequency f_{c}. This characteristic frequency f_{c} defines an operating frequency range of the device with a low limit that depends on this characteristic frequency. For a quasiperiodic signal applied at the input, the fundamental frequency of which lies within the operating range thus defined, effective repulsive interaction is obtained, thereby making it possible to reduce the white noise background of this signal.

More particularly, the characteristics of the line are chosen so as to obtain a characteristic frequency f_{c} that satisfies the following: 0.3f_{c}≦f₀, where 0.3 f_{c} is the low limit of the operating range of this device.

Thus, on average, the interfluxon distance is less than the saturation value of the line. The phenomenon of repulsive interaction between the flux quanta (fluxons) results in a spatial redistribution of the flux quanta (fluxons) along the line, about a mean interfluxon value, by smoothing around a mean value, corresponding to the mean value of the time interval between two pulses. At the output, the signal has a considerably reduced standard deviation of the time intervals between pulses. In this way, the short-term noise or phase noise of the input signal is reduced.

The characteristics of a Josephson transmission line are mainly the inductances, which depend on the length of the line and on technology, especially the mutual inductance Lₘ, and on the characteristics of the junctions, namely the critical current I_{c} and the normal resistance Rₙ. In order not to overly complicate the drawing in FIG. 2, these well-known characteristics of the Josephson junctions are shown only for the first junction JJ₁.

FIG. 3 gives a practical embodiment of a phase reduction device according to the invention with a superconducting circuit of the Josephson transmission line type, comprising a plurality of Josephson junctions, in a planar technology based on a thin film of a high-T_{c} superconductor on a bicrystal substrate.

Two substrates 1 and 2, typically SrTiO₃ substrates or else MgO or YSZ substrates, the crystal axes of which have an angle difference in the surface plane, are bonded together. A superconducting film 3, typically a film of a material of the YBa₂Cu₃Oₙ form, where 6≦n≦7, is deposited (by epitaxy) on the surface plane of the bicrystal astride the bond line of the bicrystal substrate, so that a grain boundary 4 grows right along the bond, beneath the superconducting film, equivalent to an electrical barrier. The film is then etched into a ladder pattern, each rung of the ladder corresponding to a Josephson junction.

In the example, the width w of a rung is around 5 microns, the length 1 of a rung is around 20 microns and the space h between two rungs is of the same order (20 microns) . The film itself has a width of a few microns, for a thickness of a few tenths of a micron (for example 0.3 μm) . The substrate has a thickness of a few hundred microns, typically 300 to 1000 μm.

A current source (not shown) delivers a bias current to each of the Josephson junctions, typically of the order of 100 microamperes for the technology taken as example. In the example, this bias current is applied between two current bias electrodes C and C′ formed on a portion 3′ of the superconducting film 3, this portion being shaped (by etching) so as to distribute this current right along the line, by means of current feed branches provided in pairs b₁, b′₁, . . . b₁₀₀, b′₁₀₀, arranged on either side of the ladder forming the series of junctions. In the example, the current feed branch b₁, and its complementary branch b′₁ on the ground line side current-bias the two junctions JJ₁ and JJ₂ located on either side of these branches. For a line comprising two hundred Josephson junctions, the current source is designed to deliver a bias current of the order of a few tens of milliamps, for example 20 mA, distributed along the line.

The input and output signal electrodes A, M, B, M′, typically made of copper or gold, are formed at each end of the film, and on either side of the grain boundary 4.

For example, a Josephson transmission line comprising two hundred junctions, with a length of about 2 millimeters, with a critical junction current I_{c} of 125 microamperes and a normal resistance Rₙ of 2 ohms defining a characteristic frequency f_{c}, where f_{c}=I_{c}Rₙ/φ₀=125×10⁻⁶×2/2.07×10⁻¹⁵ weber=116 gigahertz, is defined in technology based on niobium superconducting films (0.1 μm thin films) with a high critical temperature below 30 kelvin and with a 100 microamperes bias current (<I_{c}) for each junction. If a clock signal of fundamental frequency f₀(≦f_{c}/3) of around 50 to 100 gigahertz and having pulses that are very offset over time (short-term noise) is applied as input to this line, it is possible to provide as output a signal Sₒᵤₜ whose white noise/signal ratio is lowered by a factor of 10, i.e. of around −130 to −140 dB_{c} (instead of −115 to −120 dB_{c} at the input).

FIG. 4a shows schematically the lattice structure of the fluxons generated in such a line under the effect of a voltage pulse signal Sᵢₙ applied as input.

If the line is represented as a channel 5, the voltage pulses of the signal Sᵢₙ are injected at one end of this channel, at a clock frequency f₀. Fluxons flx₁, flx₂, . . . flxₘ are generated in the channel 5 and are spatially organized along a one-dimensional lattice corresponding to the direction of propagation of the fluxons in the line.

Because a transmission line is used, that is to say a line comprising a large number of junctions so that the statistics of large numbers apply (as opposed to a superconducting logic circuit of the type comprising only a small number of junctions, such as a shift register), a spatial redistribution effect occurs by the smoothing of the interfluxon distance around a mean value d₀, which corresponds to a mean value of the time interval between two pulses of the input signal. In other words, the standard deviation of the values of the time intervals between the pulses in the output signal is reduced. More precisely, and shown in FIG. 4b, the phase noise of the signal Sᵢₙ applied as input is manifested in this signal by a dispersed temporal distribution. The fluxons generated by this signal are also spatially dispersed in the line, as shown schematically in FIG. 4b. Since the characteristics of the line (f_{c}) are chosen so that the distance between the fluxons generated by the input signal Sᵢₙ is on average smaller than the saturation value of the line, there is repulsive interaction between the closest neighbor fluxons. In the figure, these repulsions are indicated by arrows. In the example shown in this figure, it is assumed that the saturation value corresponds to a time difference of 22 picoseconds. Thus, whenever the interfluxon distance corresponds to a time difference smaller than this value, the mutual repulsion produces its (flx₁−flx₂, flx₂−flx₃, flx₄−flx₅) effects. If this distance is greater, there are no (flx₃−flx₄) effects. After a transient phase corresponding in practice to around twenty pulses, the fluxons are spatially redistributed in the line around a smoothed value of the interfluxon distance. In the example shown schematically in FIG. 4c, this smoothed value corresponds to a time difference between two pulses of the output signal Sₒᵤₜ of 20 picoseconds.

The output signal thus has its voltage pulses more uniformly distributed, corresponding to a reduction in the phase noise level, compared with the signal level at the fundamental frequency f₀. In practice, with a transmission line as shown in FIG. 3, a reduction by a factor of 10 in the N₂/N₁ ratio (FIG. 1) may be observed.

The spatial separation and, therefore, the interactions depend on the ratio of the fluxon propagation speed to the signal frequency. The fluxon speed may be varied by modifying the bias current. The bias current may therefore be adjusted according to the frequency of the input signal, if so required.

FIGS. 5a and 5b illustrate an alternative embodiment of a phase reduction device based on a superconducting Josephson transmission line circuit. In this embodiment, the superconducting circuit comprises two Josephson transmission lines. A substrate 1 and a substrate 1′ are then bonded on either side of a substrate 2, to form a tricrystal substrate. A superconducting film is deposited on the zones 3a and 3b, one above each bond line, so as to grow a respective grain boundary 4a, 4b. In these figures, the current feed branches distributed along the line are wires, typically copper wires, corresponding contact pads 6 being provided on the films.

Such a construction allows the effectiveness of the spatial redistribution in the lines to be improved, by adding another dimension to the phenomenon of interaction between the fluxons. By placing the films on the zones 3a and 3b spaced apart with a gap such that the distance between a fluxon in one film and a fluxon in the other film is shorter than the saturation value, the same interaction phenomenon is observed. In other words, for a superconducting circuit based on two Josephson transmission lines, the fluxons generated in the circuit are organized along a two-dimensional periodic lattice. Typically, for the numerical examples of the line characteristic and frequency (f₀) values given above, a gap of a few microns must be provided.

In order for this effect to be effective, it is necessary to favor a stable (staggered) configuration of the two-dimensional periodic lattice of the fluxons with respect to the superconducting circuit, typically on a triangular base. Otherwise, the repulsion may have a random effect, being in the direction of propagation x of the line or in the opposite direction. This is therefore an unstable situation. Referring to FIG. 5a, in which the two films forming the Josephson transmission lines are perfectly aligned along x and y, the desired lattice is obtained by phase-shifting the signal applied as input to the second line by π. A two-dimensional triangular-based periodic lattice is obtained, as illustrated in FIG. 5b. The fluxon fix of a line then undergoes the interactions due to four fluxons, namely two fluxons flx₁ and flx₂ on either side of this fluxon flx, on the same line, and two fluxons flx₃ and flx₄ on the other line, located on either side of the bisector 7 of this line passing through the fluxon flx.

The π phase shift may be applied in various ways, as shown in FIGS. 6a and 6b.

In FIG. 6a, the π phase shift is applied to the input signal Sᵢₙ. It is then preferable for the signal coming from the quasiperiodic source 100 to be applied to a circuit 101 in order to be split into two as output. An example of this splitter circuit 101 produced in RSFQ logic is shown in detail in the figure, as a practical example. It delivers two signals in phase as output.

In FIG. 6b, the π phase shift is applied to the output signal S_{out,1} of the first line, this signal being injected into the second line. In this case, the fluxons at the start of the first line benefit from the spatial redistribution already obtained at the output of this first line—this is a positive feedback effect. An interconnection line 102 is then provided in order to feed the output signal from the first line as input for the phase shifter of the second line. This line is typically produced in technology of the coplanar, strip or microstrip type, with materials that are compatible with the Josephson transmission line technology used, or may also be a Josephson transmission line.

The two Josephson transmission lines may not be accurately aligned on the substrate, and the interconnection line 102 may also introduce a delay, such that the output signals S_{out,1} and S_{out,2} are not perfectly π phase-shifted. In this case, the interactions between the lines may not be optimal. Advantageously, the bias current I_{b} of one or more junctions may advantageously be locally modified in order to locally adapt the fluxon propagation speed. This correction is easily applied owing to the distribution of the current right along the line, by current feed branches (FIG. 3) or current feed wires (FIG. 5a). Thus, provision is made for the bias current I_{b} of the junctions to be preferably variable, this being able to be adjusted for each junction or each group of junctions.

It is also possible to provide more than two transmission lines in parallel in the surface plane of the substrate. FIG. 6c illustrates an example of a circuit comprising three Josephson transmission lines. To obtain a positive inter-line interaction effect, which favors the displacement of the fluxons along the propagation direction x of the lines, a central line Li₁, which receives the input signal Sᵢₙ as input, and two lines Li₂ and Li₃ on either side of it, which receive a π-phase-shifted signal as input, which may be the input signal Sᵢₙ as shown (in FIG. 6a) or the output signal S_{out,1} of the first line (FIG. 6b), are provided. Again, the fluxons are organized along a two-dimensional periodic lattice, but the number of lines of this lattice is increased. In this way, the fluxons of the central line Li₁ are subjected to the interactions from their own line and to the interactions due to the other two lines, that is to say for each fluxon up to six interactions due to the six closest neighbor fluxons, two per line.

By increasing the number of lines in parallel, the number of interactions is increased. In the three-line example (FIG. 6c), the central line Li₁ benefits from the interactions due to the two lines Li₂ and Li₃ located on either side of it, but the lines Li₂ and Li₃ each benefit only from the interactions due to the line Li₁.

The choice of a larger number of lines will depend on the design of the device that the application can accept. It should be noted that in the case of n lines in parallel, each line may then be made shorter, that is to say with fewer junctions, owing to the retroactive effect of the redistribution combined with the additional dimension of the interactions in the two-dimensional lattice thus formed. The designs are evaluated in such a way that the statistics of large numbers can apply, in order to produce the desired effect of smoothing the interfluxon distances.

In general, in the case of n lines in parallel, signals are applied alternately, namely the input signal to one line and then the phase-shifted input signal to the next line (by means of a phase shifter circuit—FIG. 6a). For example, the even-order lines receive the input signal (Sᵢₙ) and the odd-order lines receive the phase-shifted input signal. The output signal of the device is delivered as output from one of the lines.

FIG. 7 shows an example of a phase noise reduction device used in a frequency doubler circuit. In the example, the circuit comprises two lines in parallel, the first receiving the input signal Sᵢₙ and the other the phase-shifted input signal. The first line delivers the signal S_{out,1} as output while the other line delivers the signal S_{out,2} as output.

The two lines are placed in such a way that the fluxons in the lines interact with one another, reducing the short-term phase noise. The two output signals S_{out,1} and S_{out,2} thus obtained as output are applied as inputs to an RSFQ (combiner) logic circuit, which delivers as output a signal S_{(2f0)} having a frequency twice that of the input signal Sᵢₙ, with a low phase noise.

Thus, a phase noise reduction device according to the invention may advantageously be used in a frequency doubler circuit and more generally in a frequency multiplier circuit, by circuit cascading of this type, while still maintaining an extremely low phase noise background.

FIG. 8a shows another example of an embodiment of a Josephson transmission line, which can be used in all the alternative embodiments of a phase reduction device according to the invention that have just been described. FIG. 8b may be used in a structure consisting of a single line or of multiple lines, the lines then being stacked vertically. In these two FIGS. 8a and 8b, the lines are produced in a ramp-edge junction technology, which is an SNS (standing for Superconductor/Normal or insulating material/-Superconductor) multilayer technology. The normal or insulating material is for example PrBaCuO, which is a nonsuperconductor, the material having a structure similar to YBaCuO, compatible with the lattice cell characteristics of the superconductor. A comb shape comprises a first superconducting film 9 (a thin film) deposited on a heterostructure (8) of normal or insulating material deposited on the superconducting base electrode shown in gray in the figures, on a substrate. The teeth of the comb have the shape of a ramp decreasing toward the substrate. A thin layer of insulation and a second superconducting film 10 in the form of a comb are deposited on the substrate, the end of the teeth of this comb being above the end of the teeth of the superconducting film 9 of the first comb. The junctions JJ₁, JJ₂, . . . , etc. are thus formed in the plane at the point where the layer 8 of normal or insulating material is thinned, between the two superconductor films 9 and 10.

FIG. 8b is a variant of FIG. 8a in which the second superconductor film 10 is “folded” over the first film 9, which makes it possible to significantly save surface area.

FIG. 9a shows another embodiment of a phase noise reduction device consisting of a superconducting circuit based on a voltage pulse transmission line. In this embodiment, the transmission line is produced by a long Josephson junction. Such a junction is typically obtained in an SIS trilayer technology, preferably based on the low-T_{c} superconductor: a thin film 20 of normal (or insulating) material (for example Al₂O₃), forming a barrier between two layers 21 and 22 of superconductor (for example niobium). A bias current i smaller than the critical current I_{c} of the long Josephson junction is applied between the two superconductor layers 21 and 22. Applying pulses to the input of the line generates vortex (Josephson vortex) fluxes in the layer of normal material which, under the effect of the bias (DC) current of the line (the Lorentz force), propagate toward the output. The flux quantum associated with each vortex is equal to φ₀. The same repulsive interaction effects apply to these vortex fluxes generated under the effect of the clock signal Sᵢₙ, which are organized in the line as a one-dimensional periodic lattice and which propagate along the propagation direction x of the line.

In a typical embodiment, such a line will have a length of around one hundred nanometers.

Several of these lines may be placed in parallel in order to obtain the same advantageous effects seen previously, by stacking them vertically as shown in FIG. 9b, this being feasible but more tricky.

The current is preferably distributed along the line as shown in FIG. 9b.

The level of the bias current may be adjusted according to the frequency of the input signal.

Another embodiment of a phase noise reduction device according to the invention is shown in figures 10a and 10b, which corresponds to a type II superconductor circuit based on an active Abrikosov vortex flux-flow transmission line. The Abrikosov vortex flux principle is briefly the following: in the presence of an increasing magnetic field, the superconductor switches to a normal/superconductor hybrid state. Currents are generated in the surface of the superconductor which tend to shield the magnetic field. The magnetic flux that enters the superconductor is in the form of field lines grouped together on the surface of a disk a few tens of ångstroms in radius. The flux contained in this small zone bounded by magnetic field shielding currents that circulate around it is equal to a flux quantum φ₀. These vortex fluxes are organized on the surface as a triangular-based periodic lattice, as shown in figure 11. By injecting a suitably directed DC current, this vortex flux lattice propagates translationally, along a direction orthogonal to the current (Lorentz force).

One advantage of such a transmission line is that the vortex fluxes are organized “naturally” as a triangular-based two-dimensional periodic lattice.

By suitably current-biasing the device, the application of an electromagnetic signal as input generates a vortex flux lattice, which moves in lines Lᵥ (FIG. 11) along this lattice structure. At the output, a receive device (any matched load) receives the associated voltage pulses.

Furthermore, if in the superconducting material used, for example NdBa₂Cu₃O₇, the twin planes are arranged in parallel, this organization becomes natural—the lines Lᵥ correspond to the twin planes.

According to the invention, the active superconductor circuit comprises (FIGS. 10a, 10b), a film (thin layer) 13 of type II superconductor, such as YBa₂Cu₃O₇ or NdBa₂Cu₃O₇ deposited (by epitaxy) on a substrate 12, for example an SrTiO₃ substrate. A slot 14 is made over the entire width of the film, leaving only a microbridge 15 of superconducting film between the two parts 13a and 13b of the film, on either side of the slot. This microbridge has a height equal to the thickness of the film or less. In the example, this microbridge has a height e of around 0.1 microns, for a microbridge length L, along the direction of the slot, less than one hundred microns and a width W, which is also the width of the slot, of greater than one hundred microns.

Two bias electrodes 16 and 17, for applying a DC current i of about a few milliamperes, are provided at each end of the film. Two input signal electrodes 18 and 19 are provided at one end of the slot, on each part 13a, 13b of the film on either side of the slot, in order to apply the AC input signal Sᵢₙ, such that it imposes, periodically at the input of the microbridge, a local magnetic field Bₑ which is greater than the critical field, so as to generate vortices v at the period of this signal. The input signal may be a voltage pulse signal. It is also possible to apply an AC signal of the sinusoidal type. In practice, the clock signal source (not shown) is impedance-matched, relative to the impedance of the microbridge (a few tens of ohms).

Two output signal electrodes 20 and 21 are provided at the other end of the slot, on each part 13a, 13b of the film on either side of the slot, in order to receive as input the voltage pulses corresponding to the in-line transmission of the vortices (FIG. 11).

In practice, each voltage pulse (or each positive peak voltage of the AC signal) passes through the local magnetic field Bₑ as input of the microbridge above the critical field of the superconducting film causing a collection of vortices to nucleate. The DC current i applied orthogonally (Lorentz force) along the appropriate direction causes the vortices to circulate.

The vortices are generated by modulating the magnetic field by the clock signal applied as input. Suitable biasing of the circuit causes the vortices to propagate along the desired direction, toward the output Sₒᵤₜ of the device.

To further promote the displacement of the vortices in the desired direction, it is possible to place the device in a low DC magnetic field B, for example of about twenty millitesla, suitably oriented so that the vortices are oriented in the same direction, for example by placing a pair of Helmholtz coils on either side of the circuit.

Such a superconducting circuit may advantageously be used in a frequency doubler stage as indicated above, with another similar circuit associated with a phase shifter circuit, in a frequency multiplication device.

Thus, in this embodiment, the transmission line comprises a film of type-II superconductor in the hybrid state, deposited on a crystalline substrate. The film is current-biased at its ends and includes a slot in the width direction, except at the place of a microbridge, the slot separating the film into two parts. The quasiperiodic signal is applied at one end of the slot, between the two parts of the film, and the output signal is obtained at the other end of the slot, between the two parts of the film.

Advantageously, such a superconductor device is immersed in a DC magnetic field oriented perpendicular to the surface plane of the slot.

The invention that has just been described thus uses the periodic structure of the lattice of flux quanta (fluxons, vortices) that are generated and the repulsive interaction property of these flux quanta (which can be likened to magnetic dipoles) in order to reduce the phase noise of a signal coming from a quasiperiodic source. This device according to the invention is advantageously used to deliver a multiple frequency signal without a phase noise degradation.

The invention applies more particularly in the high-frequency and very high-frequency field in rapid electronic systems. In particular, such a device may be used in RSFQ logic circuits.

1. A device for reducing the phase noise of a quasiperiodic signal coming from a quasiperiodic source of fundamental frequency f₀, comprising a physical system for transmitting pulses by transferring particles, said physical system being defined so as to have a characteristic frequency f_{c} defining an operating frequency range of the device with a low limit that is dependent on said characteristic frequency, in such a way that, for the quasiperiodic signal applied as input, said particles have a mutual repulsive interaction and said physical system delivering, as output, pulses at the fundamental frequency f₀.

2. The device for reducing the phase noise of a quasiperiodic signal, coming from a quasiperiodic source of fundamental frequency f₀ as claimed in claim 1, comprising a superconducting circuit with an active line for voltage pulse transmission by transferring quanta of flux φ₀, said circuit being defined so as to have a characteristic frequency f_{c} such that 0.3 f_{c}, is less than or equal to the fundamental frequency f₀ of the quasiperiodic signal applied as input, and delivering, as output, a voltage pulse signal of fundamental frequency f₀.

3. The phase noise reduction device as claimed in claim 1, comprising at least two superconducting circuits, namely a circuit for a π phase shift of the input or of the output of one of said circuits and a combiner circuit for producing a frequency-doubling stage in a frequency multiplication circuit.

4. The phase noise reduction device as claimed in claim 2, wherein the superconducting circuit comprises a Josephson transmission line geometrically defined with said characteristic frequency.

5. The phase noise reduction device as claimed in claim 4, wherein the Josephson transmission line is a long Josephson junction.

6. The phase noise reduction device as claimed in claim 4, wherein said transmission line comprises a plurality of parallel-shunted Josephson junctions.

7. The phase noise reduction device as claimed in claim 6, wherein each Josephson transmission line is of the type comprising a line with bicrystal junctions.

8. The phase noise reduction device as claimed in claim 6, wherein each Josephson transmission line is of the type comprising a line with ramp-edge junctions.

9. The phase noise reduction device as claimed in claim 5, wherein the superconducting circuit comprises several Josephson transmission lines placed in parallel.

10. The phase noise reduction device as claimed in claim 9, wherein it comprises a π phase shift circuit at the input of at least one transmission line, applying a phase-shifted signal to said line.

11. The phase noise reduction device as claimed in claim 10, wherein said phase shift circuit receives as input the input signal of the device.

12. The phase noise reduction device as claimed in claim 10, wherein said phase shift circuit receives as input the output signal from a line.

13. The phase noise reduction device as claimed in claim 11, wherein the superconducting circuit comprises n Josephson transmission lines of rank 1 to n in one and the same surface plane of a substrate, with n an integer ≧2, and in that one signal among the input signal and the phase-shifted input signal is applied to the lines of even rank and the other signal is applied to the lines of odd rank, the output signal being delivered as output of one of the n lines.

14. The phase noise reduction device as claimed in claim 5, comprising current bias means with a plurality of branches for feeding the current, in order to distribute this current along each Josephson transmission line.

15. The phase noise reduction device as claimed in claim 14, comprising means for adjusting the intensity of the bias current according to the frequency of the input signal.

16. The phase noise reduction device as claimed in claim 2, wherein the superconducting circuit comprises a vortex flux-flow voltage-pulse transmission line.

17. The phase noise reduction device as claimed in claim 16, wherein said transmission line comprises a superconducting film of type II in the hybrid state, deposited on a crystalline substrate, said film being current-biased at its ends and comprising a slot in the width direction, except at the point of a microbridge, said slot separating the film into two parts, and wherein the quasiperiodic signal is applied to one end of the slot, between the two parts of the film, and the output signal is obtained at the other end of the slot, between the two parts of the film.

18. The phase noise reduction device as claimed in claim 16, wherein said superconducting device is immersed in a DC magnetic field oriented perpendicular to the surface plane of the slot.

19. Phase noise reduction device as claimed in claim 1, wherein the superconducting circuit or circuits use a high critical temperature superconductor.

20. Phase noise reduction device as claimed in claim 2, wherein the superconducting circuit or circuits use a high critical temperature superconductor.
